(19) United States
(12) Patent Application Publication
(10) Pub. No.: US 2023/0393945 A1
(43) Pub. Date: Dec. 7, 2023

(54) RADIATION INDUCED FAULT SELF-PROTECTING CIRCUITS AND ARCHITECTURES

(71) Applicant: UNIVERSITE DU LUXEMBOURG, ESCH-SUR-ALZETTE (LU)

(72) Inventors: Rafal GRACZYK, ESCH-SUR-ALZETTE (LU); Marcus VÖLP, ESCH-SUR-ALZETTE (LU); Paulo ESTEVES-VERÍSSIMO, ESCH-SUR-ALZETTE (LU)

(21) Appl. No.: 18/269,068

(22) PCT Filed: Jan. 28, 2022
(86) PCT No.: PCT/EP2022/052060

§ 371 Date: Jun. 22, 2023

(30) Foreign Application Priority Data
Jan. 29, 2021 (LU) LU102471

(51) Int. Cl. G06F 11/14; G06F 11/07

(52) U.S. Cl. CPC G06F 11/1438; G06F 11/0793; G06F 2201/805

(57) ABSTRACT

The present invention pertains to electronics (circuits and systems comprising such circuits, specifically like tiled multi- and manycore systems) for use in increased radiation environments. The invention provides (operating) methods and apparatuses (systems) for mitigating radiation effects in the (main) circuits (also denoted tiles) defining these apparatuses by adapting those or providing those with additional building blocks, enabling use of a depowering technique The invention also mitigates radiation effects in those building blocks (circuits or subcircuits) of the apparatuses themselves. The invention enables to retain full functionality on those resources of the chip that are not currently undergoing a depowering cycle, hence avoids power cycling those all simultaneously.

### FIELD OF THE INVENTION

The present invention pertains to electronics (circuits and systems comprising such circuits, specifically like tiled multi- and manycore systems) for use in increased radiation environments, such as in the vicinity of a reactor chamber of nuclear plants, in aircrafts, in spacecrafts operating in near earth orbit, deep space and on extra-terrestrial celestial bodies, as well as in nuclear medicine for radiation therapy equipment control, in particular electronics (and related execution or operating methods) capable to cope the problem arising while using electronics in such radiation environment.

### BACKGROUND OF THE INVENTION

General

Radiation affects integrated circuits by causing single and multiple bit upsets as well as short circuits through latch ups as described further. Bit upsets are typically of a non-persistent nature, changing the state of an electronic circuit (e.g., a memory cell), but once this state is overwritten the circuit continues to function normally. In some situations, upset induced state changes may become persistent, freezing the state and rendering the circuit unusable or causing the circuit to become malicious and detrimental to other circuits if not special action is taken.

As mentioned above latch-ups is one of those effects that when left untreated may lead to permanent damage by locally overheating the semiconductor die, resulting in burnout or thermal stresses and mechanical failure modes.

Conventional methods aim at avoiding these effects by applying costly special purpose radiation hardened designs or by using special materials for manufacturing that are known to not exhibit such effects. (such as Silicon on Insulator). Others mitigate these effects at chip granularity, turning off and resetting the whole IC to remove the Single Event Latch ups by removing the power supply for long enough to suppress the unwanted thyristor effect in the semiconductor die and Single Event Upsets by re-instantiating the software stack and uploading fresh memory and register contents.

To remain operational, conventional systems must contain multiple chips, implementing redundant functionality and mitigation methods must make sure to not disable multiple chips at a time. Increasing core counts in multi- or many-processor systems on a chip (MPSoC) makes such solutions increasingly inefficient, due to costly cross-chip communication and due to the requirement to power cycle all cores in a single chip simultaneously.

### Technical Definitions

Single Event Latch-up (SEL) is a known radiation effect that may occur in microelectronic circuits that are manufactured in CMOS family technologies other than CMOS Silicon-On-Insulator (SOI) or technology equivalents which do not introduce parasitic thyristor in semiconductor bulk. SELs result in parasitic thyristor (silicon-controlled rectifier, SCR) switch on by electric charge generated during high energy particle interaction with the semiconductor lattice. SEL can be switched off only by removing the power supply from the affected semiconductor device or part of it. Untreated SEL may lead to thermal breakdown of the semiconductor device, namely, physical burn-out or semiconductor die cracks due to temperature induced thermal stresses. Latch-ups are induced locally in the semiconductor die, however there is the possibility of independent, multiple Single Event Latch-up occurrence, in physically separated semiconductor devices (and hence in several tiles) depending on radiation levels (particle flux and particle energies).

Single Event Functional Interrupt (SEFI) is a condition where some or the whole functionality of an electronic device ceases to operate due to internal malfunction. This type of fault is dormant—it exists in the tile caused by transient, microlatch-up or by other reasons, but reveals itself only during attempts to execute affected functionality. Micro latchup is a Type of SEL whose occurrence, due to the complex structure and topology of state of the art integrated circuits, is not immediately visible. Micro latchups cannot be easily detected by current measurement due to:
Complex (large variability, high surges) nominal power consumption signatures of integrated circuits.
The latch-up is weak (the parasitic SCR resistance is higher than typical) thus resulting in relatively low fault currents.

### Special Own Prior Art

Patent Application EP3580681A1 mentions techniques for preventing the uncontrolled mitigation of single- or multiple-event upset caused faults, more in particular offers methods and apparatuses for eliminating single-point of failure syndromes in low-level system software (e.g., the operating system kernel) and, to a certain degree, in hardware. These techniques also leverage architectural hybridization to extend tiled multi- and manycore systems on a chip with a combination of access controls and voters (which together form a protection units and which interoperate in a way that any critical operation, in particular changing the state of the access controls, requires consensus in a fault-threshold exceeding quorum of replicas).

The above mentioned approach like many other systems, operates under the inherent assumption that trusted-trustworthy components exclusively fail by crashing in a recognizable manner and that after such a crash, no damage can arise from the crashed component or from leaving alone its associated tile. Obviously, radioactive environments violate these assumptions, because SELs may very well build up in crashed trusted-trustworthy components or in tiles they can no longer control after crashing.

### Aim of the Invention

It is the aim of the invention to provide electronics (circuits and systems comprising such circuits) (and related execution or operating methods) capable to cope with (radiation induced) (non-transient) faults, especially latch ups, arising while using electronics in such radiation environment by explicitly exploiting that fact that latch-ups are effects that can be removed (e.g., by removing and re-establishing power supply from the circuit, also defined as power cycling) without relying entirely on radiation-hardening technology (although it is in principle compatible therewith). Avoiding radiation-hardening technology ensures that the best technology in terms of power consumption & processing capabilities can be used.

It is the aim of the invention to provide electronics to provide cost-efficient, higher performance, but not (entirely relying on) radiation-hardened MPSoCs (hence circuits and systems comprising such circuits) for use in increased radiation environments.

It is the aim of the invention, to also cure, on top of latch ups problems, to also tackle single Event Functional Interrupt (SEFI), like Micro latchup.

One may emphasize that the systems that are demanded to be safe and secure are benefiting from the invention in particular, especially when one insist on relying on reusing chips designed for use on the ground in radiation sensitive environments like space.

### SUMMARY OF THE INVENTION

The invention provides (operating) methods and apparatuses (systems) for mitigating radiation effects in the (main) circuits (also denoted tiles) defining these apparatuses by adapting those or providing those with additional building blocks, enabling use of a depowering technique. The invention allows working entirely on non-radiation hardened chips. The invention also mitigates radiation effects in those building blocks (circuits or subcircuits) of the apparatuses themselves. The invention enables to retain full functionality on those resources of the chip that are not currently undergoing a depowering cycle, hence avoids power cycling those all simultaneously.

The present invention allows augmenting state-of-the art MPSoCs but also novel designs with the ability to withstand radiation-hard environments without having to power cycle all cores simultaneously. It is worth emphasizing that to achieve this, conventional systems must be implemented in a radiation-hardened manner, onto the MPSoC, while making sure that the effects of single event upsets cannot propagate in an uncontrolled manner where they would affect the whole software stack of the MPSoC. The principles of such a protection for radiation-hardened implementations (e.g., on Silicon On Insulator), where latch-ups cannot occur, has already been shown.

With the invention different kinds of main circuits: active ones (the cores+periphery, like the network interface card with their local memories, which we summarize as tiles) and passive ones (the network segments connecting it to the other tiles in the on chip network, and shared on- or off-chip memory blocks) can be distinguished. The latter we also call resources, in the sense that a tile operates on data in main memory. Within the invention one can power cycle them all, possibly by first moving their state.

The tiles can be coprocessors, DSP blocks, communication interfaces, memory/memory controllers. This could also mean the routers of network on chip. Also the communication fabric—can be considered as susceptible to radiation induced faults for instance faults are happening in multiplexers/demultiplexers or address decoders. In essence a tile is anything which contain functionality (processor cores etc, but also including communication means like routers, address decoders, etc). Alternatively tiles can be denoted as everything to which the failure model addressed by the invention is applying.

The present invention improves over conventional multi-chip solutions, by ensuring that a subset of on-chip resources can be recovered while retaining the functionality necessary to operate the system it controls. From a birds eye perspective, the solutions discussed integrate power cycling control, which in conventional systems must be implemented in a radiation-hardened manner, onto the MPSoC, while making sure that the effects of single event upsets cannot propagate in an uncontrolled manner where they would affect the whole software stack of the MPSoC.

It is worth emphasizing here that simple integration of latch-up control on a technology node, which is susceptible to latch-ups, leaves this control circuit susceptible to latch-ups. Fine grain control through an external (hardened) latch-up control circuit induces high costs (e.g., multiple external wires) to interface with the necessary anchor points on chip for depowering cores and for protecting the system from uncontrolled upset propagation, and these interfaces and anchor points, being implemented on the non-hardened MPSoC, would still remain susceptible to latch-ups.

The invention leverages on the concept of architectural hybridization, by introducing special (less vulnerable to radiation) (protection) circuits (compared to the main circuit it protects) to prevent uncontrolled propagation of accidental and malicious faults, such circuit being designed to execute or support (part of) the steps necessary for power cycling and, later on, re-instantiating the functionality implemented by a core after removing latch-ups.

The invention leverages on the concept of rejuvenation in that it rejuvenates the individual tiles (main circuits) and other supporting circuits (e.g., trusted-trustworthy components like the special protection circuits mentioned above and network segments) by power cycling all of them and by re-instantiating those implemented as a reconfigurable fabric (e.g., as FPGAs).

In an embodiment of the invention also microlatchups are tackled. Since, microlatchups are impractical, if not impossible to detect through current measurements, the capability of a processing unit to produce trustworthy results cannot be ensured (Single Event Functional Interrupt). One must therefore rely on proactive techniques, such as periodic power cycling, to remove dormant, but not yet permanent, faults.

Patent Application P138211 EP mentions techniques for preventing the uncontrolled mitigation of single- or multiple-event upset caused faults, more in particular offers methods and apparatuses for eliminating single-point of failure syndromes in low-level system software (e.g., the operating system kernel) and, to a certain degree, in hardware. These techniques also leverages architectural hybridization to the extend tiled multi- and manycore systems on a chip with a combination of access controls and voters (which together form a protection units and which interoperate in a way that any critical operation, in particular changing the state of the access controls, requires consensus in a fault-threshold exceeding quorum of replicas.

Contrary to systems operating under the inherent assumption that trusted-trustworthy components (like the protection circuits specially provided) exclusively fail by crashing in a recognizable and particular non-damaging manner, the invention deals with radioactive environments violating these assumptions, because SELs may very well build up in such crashed trusted-trustworthy components or in tile they can no longer control after crashing. The invention provides exactly this protection, that is, in recursively protecting trusted components and their associated tiles, while retaining the flexibility and adaptability (including to different radiation environments) that other system offers through redundant low-level system software control over all critical operations. In particular, one instance of the invention will allow such a replicated kernel, which can be made no longer to be a single-point-of-failure based on the mentioned prior-art technique, to control when which part of the MPSoC will be power cycled, according to the perceived radiation level.

Throughout the description with circuit is meant electronic circuit. With means typically one or more electric (current or voltage carrying) lines and/or including other basic circuits like switches (also denoted switching means) and/or electronic elements (like resistors) (e.g. to measure a current over a resistor as part of an electric circuit measurement) are meant, e.g. in power supply means (supply and/or ground) and/or communication connect means and the first protection means. As a further example a means (40) for detecting occurrence of such (radiation induced) (non-transient) faults can be a an over current detecting circuit as just described.

The notion of power cycling (meaning shutting down and restarting a circuit or tile) can be formulated as to disconnect from the power supply and reconnect thereto (and preferably also to other devices that the circuit is connected to). For the purpose of the invention, in particular handling or preventing at least (radiation induced) non-transient faults said disconnection is sufficiently long in time for removing said (radiation induced) faults.

The invention applies recursively the invented technique in that the main circuit is provided with a first protection means and a second protection means which in itself has a kind of protection means rather similar to said first protection means.

Hence the invention provides as first aspect a circuit (of which an example is shown in FIG. 1), adapted for assisting in recovery from (radiation induced) (non-transient) faults, comprising a main circuit; power supply means to connect said main circuit to power lines (supply and/or ground); and (or) communication connect means to connect said main circuit to communication means, characterized in that the circuit further being provided with first protection means comprising: a means for detecting occurrence of such (radiation induced) (non-transient) faults (e.g. by measuring current along the power line (see OC in FIG. 1); one or more switching means are provided in between either said power supply means or said communication connect means and said main circuit, the switching means acting upon a control signal (SHDN in FIG. 1).

The invention provides as second aspect a system (architecture), adapted for recovery from (radiation induced) (non-transient) faults (in one or more of its circuits or tiles) with one (as in FIG. 2) or more (FIGS. 3, 4, 5, 7) central control circuits, generating said control signals or the circuits or tiles, collaborative generating said control signals (FIG. 8).

The invention also pertains to all kind of simulators suitable for designing of these circuits and/or systems and/or tuning the parameters of the related methods and further pertains to all possible uses of such circuits and/or systems for instance during a mission with varying radiation levels.

### BRIEF DESCRIPTION OF THE DRAWINGS

FIG. 1 shows a circuit (tile) and an example of an ISOL isolation mechanism provided by a first protection means.

FIG. 2 shows system comprising a plurality of circuits, each provided with a (general) protection means, for instance as in FIG. 1; and a singleton power-cycling (central) control circuit or controller approach.

FIG. 3 shows system comprising a plurality of circuits, each provided with a (general) protection means, for instance as in FIG. 1; and a dual or tandem power-cycling (central) control circuit or controller approach.

FIG. 4 shows system comprising a plurality of circuits, each provided with a (general) protection means, for instance as in FIG. 1; and a triplicated power-cycling (central) control circuit or controller approach with state transfer.

FIG. 5 shows system comprising a plurality of circuits, each provided with a (general) protection means, for instance as in FIG. 1; and a dual or tandem power-cycling (central) control circuit or controller approach with state transfer.

FIG. 6 shows as additional feature an oscillator circuits for use in an oscillator based controller, which can be part of said first, second or third protection means. The oscillator is statically configured to raise SDHN and to connect OC for a time tᵢ every pᵢ with an offset ϕᵢ. Optionally a connection with the communication means is provided.

FIG. 7 introduces the notion of use of multiple control input and hence the requirement in such case to have a second protection means (providing control to said first protection means) at least having a voting circuit for voted activation of the (SHDN) signal to switch (for the purpose to power cycle).

FIG. 8 shows system (architecture, apparatus), comprising a plurality of (interconnected) circuits, for instance as in FIG. 1; and communication means to enable communication from and to said circuits between each other (power cycling control being implemented now on normal circuits or tiles) again using the notion of use of multiple control input and hence the requirement in such case to have a second protection means (providing control to said first protection means) at least having a voting circuit to switch (for the purpose to power cycle).

FIGS. 9 and 10 shows a main circuit (tile) connected or connectable to power supply means and/or communication means; and first protection means (border around the tile) with one or more switching means to disconnect therefrom (and reconnect thereto) and a plurality of second protection means, themselves having also first protection means (border around the tile) with one or more switching means to disconnect and reconnect thereto as the main circuit (tile) under control of a third protection means.

FIGS. 11 to 14 shows flow charts for the methods for the systems discussed in FIGS. 1 to 10.

FIG. 15 (left) shows a system comprising a plurality of (interconnected) circuits and FIG. 15 (right) shows a plurality of (interconnect) circuits, each provided with a (general) (most probably same or similar) protection means, although this is not required) protection means.

FIG. 16 introduces (as part of the pro-active methods) the notion of use of multiple control inputs and hence the requirement in such case to have a second protection means (providing control to said first protection means) at least having a voting circuit for voted activation of the (SHDN) signal to switch (for the purpose to power cycle) and registers.

FIG. 17 similarly introduces (as part of the combined re-active and pro-active methods) the notion of use of multiple control inputs and hence the requirement in such case to have a second protection means (providing control to said first protection means) at least having a voting circuit for voted activation of the (SHDN) signal to switch (for the purpose to power cycle) and registers and a feedback loop with over current detection signal (OC).

FIG. 18 combines the notions of 6 (oscillator based controller) with the embodiment of FIG. 16. This notion can also be combined with the embodiment of FIG. 17. Moreover the additional feature of optionally having a direct input to the switch from the communication network is shown.

FIG. 19 shows a main circuit (tile) connected or connectable to power supply means and/or communication means; and first protection means (border around the tile) with one or more switching means to disconnect therefrom (and reconnect thereto) and a plurality of second protection means (here having their voting mechanism), themselves having also first protection means (border around the tile) with one or more switching means to disconnect and reconnect thereto as the main circuit (tile) under control of a third protection means, itself combining the outcomes of the second protection means, for instance via an OR gate or another suitable Boolean function.

FIG. 20 shows a system comprising a plurality of (interconnected) circuits, each provided with a (general) (here similar) protection means, more in particular each circuit being provided with a first protection means, a plurality of (so-called) second protection means and each of these second protection means being provided also with a first protection means (as an exemplary embodiment of a recursive methodology explained in the invention).

### DETAILED DESCRIPTION

### Definition

Architectural hybridization is a concept suggesting the identification and use of trusted-trustworthy components, which follow a distinct fault model and which provide reduced functionality to enhance less trusted components. The invention leverages on this concept, by introducing trusted-trustworthy circuits to prevent uncontrolled propagation of accidental and malicious faults and to execute the steps necessary for power cycling and, later on, re-instantiating the functionality implemented by a core after removing latch-ups. Power cycling must (recursively) protect these trusted-trustworthy components to avoid permanent damage due to non-mitigated latch-ups.

Rejuvenation is a concept to return components to a state at least as good as initially. The literature distinguishes proactive and reactive rejuvenation, e.g., in the context of replication, to heal faulty or compromised replicas. The invention rejuvenates the individual tiles and other supporting circuits (e.g., trusted-trustworthy components and network segments) by power cycling them. The invention supports both software- and hardware-triggered proactive rejuvenation (e.g., periodically based on a redundant global clock signal) as well as reactive rejuvenation (e.g., upon detecting latch-ups). In particular, proactive rejuvenation is applied to protect against latch-ups that thwart detection.

Power cycling is the process of turning the device off and then turning it on again. The power supply shall be removed from (blocked, isolated) the device (electronic system, subsystem, component, integrated circuit, semiconductor die) for a period that is sufficiently long to for all the voltages, measured with respect to system ground, to drop to zero, while ensuring that no current flows through the device. This assumes that there is no parasitic supply through input/output lines of the device. State-of-the-art power cycling is controlled through external, radiation-hardened devices, which operate at the granularity of the whole chip.

Cold-space capability is a concept wherein some tiles, sets of tiles or processing nodes, are designed and manufactured in a way that they are cold-spare capable. That is, they can be power cycled without having to decouple their input/output connections. Cold spare capability allows omitting voltages removal from tile inputs-output ports, without any risk of parasitic powering occurrence through those input-output ports. In such a case, parts of the isolation circuitry, which is responsible for disconnecting cold-spare capable tiles from their communication infrastructure, are not required (but may still be present). The invention supports both cold-spare capable and incapable tiles.

A tiled Multi- or Manycore System is a hardware architecture suggesting the organization of computing and storage resources as tiles, connecting the latter through interconnects of some kind. Tiles are placeholders and instantiation points for arbitrary kinds of circuits, including cores, memories, devices, sensors, Field Programmable Gate Array (FPGA) fabric, accelerators and Graphical Processing Units (GPUs). The invention builds on and extends tiled multi- and manycore systems implemented on non-radiation hardened technology nodes.

The invention is first in general described by outlining the various figures of this description.

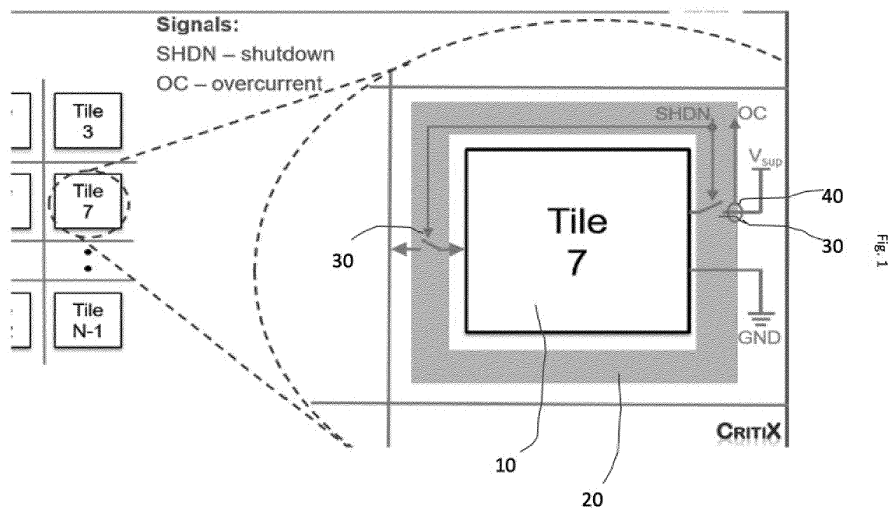

FIG. 1 shows a main circuit (tile) connected to power supply means and/or communication means; and first protection means (border around the tile) with one or more switching means to disconnect therefrom (and reconnect thereto).

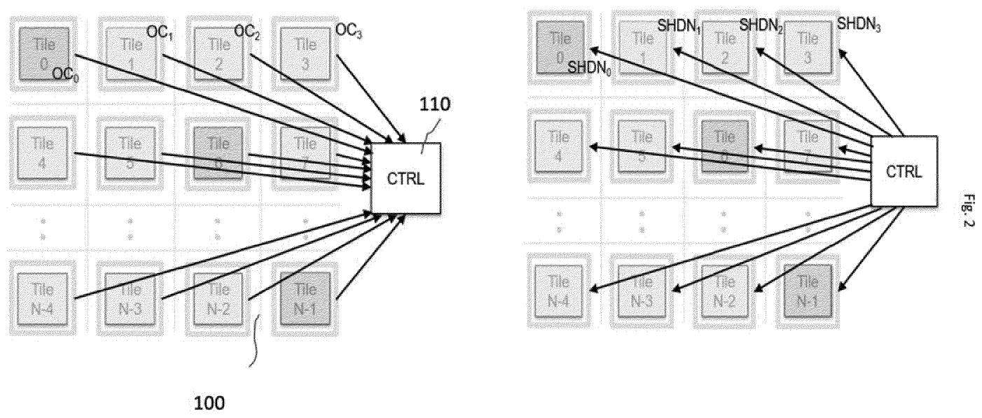

FIG. 2 shows system (architecture, apparatus), comprising a plurality of circuits as in FIG. 1; and communication means to enable communication from and to said circuits from a central control circuit.

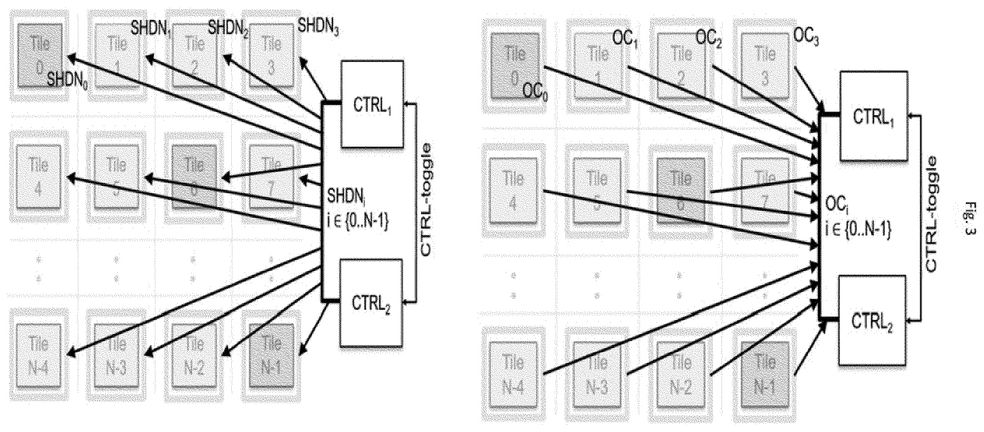

FIGS. 3, 4, 5 and 7 shows system (architecture, apparatus), comprising a plurality of circuits as in FIG. 1; and communication means to enable communication from and to said circuits from a plurality of central control circuit.

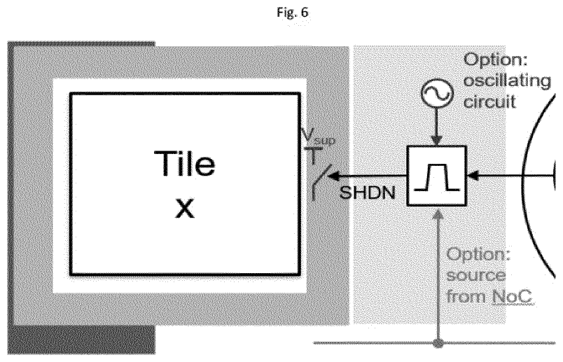

FIG. 6 shows additional features, which can be part of said first, second protection means and/or third protection means.

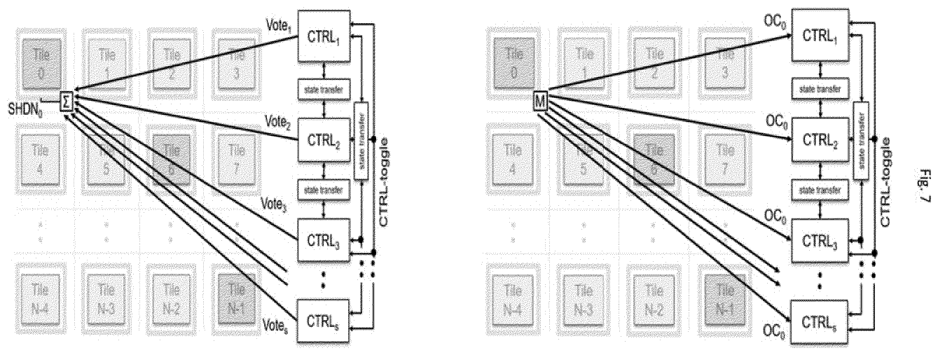

FIG. 7 introduces the notion of use of multiple control input and hence the requirement in such case to have a second protection means (providing control to said first protection means) at least having a voting circuit.

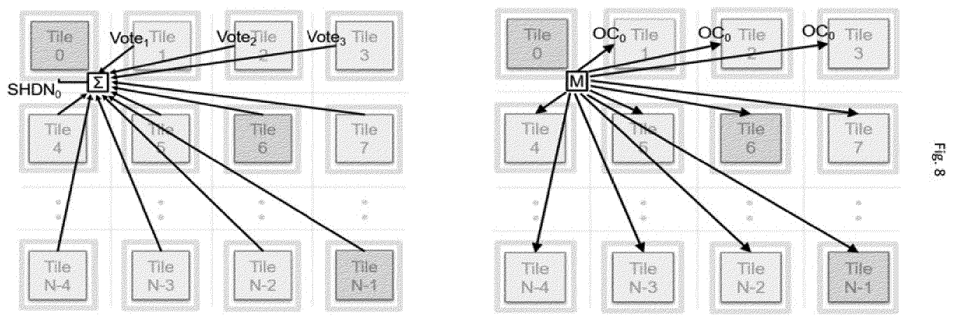

FIG. 8 shows system (architecture, apparatus), comprising a plurality of circuits as in FIG. 1; and communication means to enable communication from and to said circuits between each other, again using the notion of use of multiple control input and hence the requirement in such case to have a second protection means (providing control to said first protection means) at least having a voting circuit.

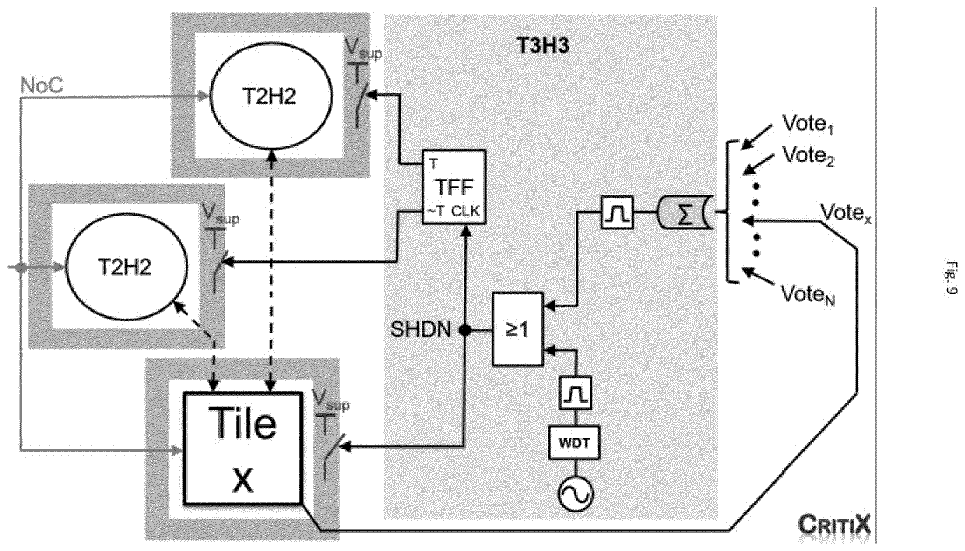

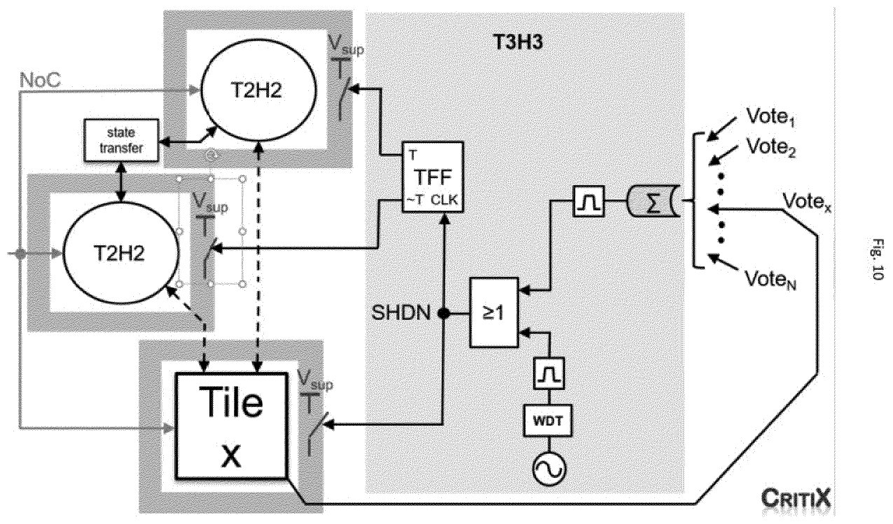

FIGS. 9 and 10 shows a main circuit (tile) connected or connectable to power supply means and/or communication means; and first protection means (border around the tile) with one or more switching means to disconnect therefrom (and reconnect thereto) and a plurality of second protection means, themselves having also first protection means (border around the tile) with one or more switching means to disconnect and reconnect thereto as the main circuit (tile) under control of a third protection means.

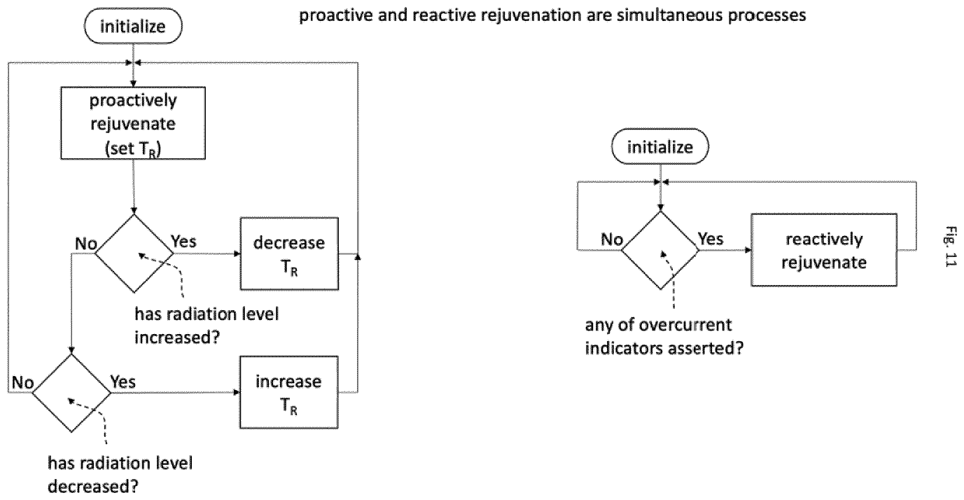

FIGS. 11 to 14 shows flow charts for the operating or executing methods for one or more of the systems discussed in FIGS. 1 to 10.

FIG. 11 emphasized the simultaneous use of methods for re-active fault removal and a method for proactive fault removal, in particular for the proactive (so called rejuvenation) the periodicity is radiational level dependent.

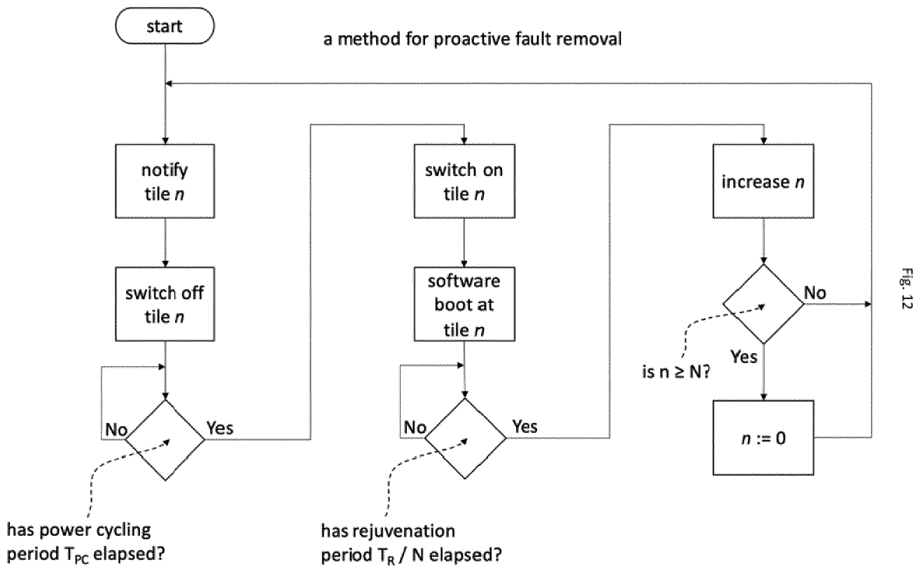

FIG. 12 shows a method for proactive fault removal.

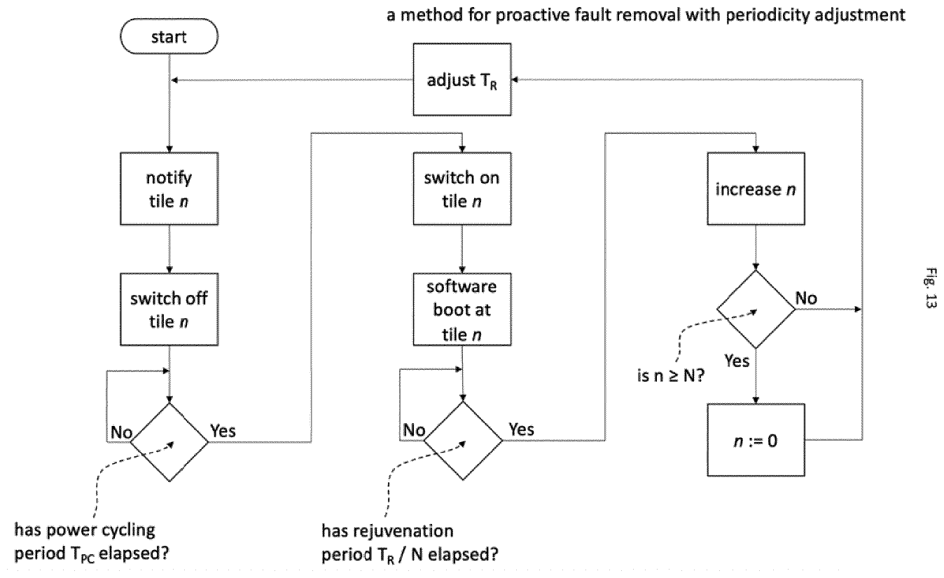

FIG. 13 shows a method for proactive fault removal, in particular for the proactive (so called rejuvenation) the periodicity is radiational level dependent.

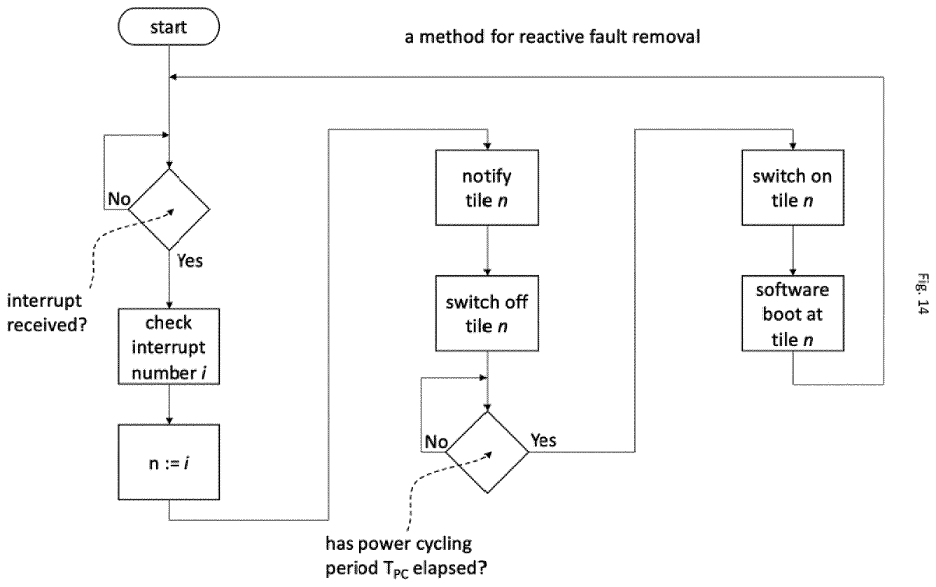

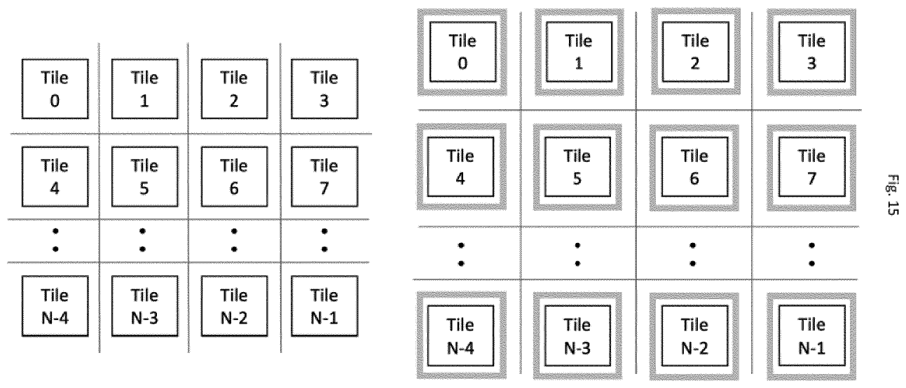

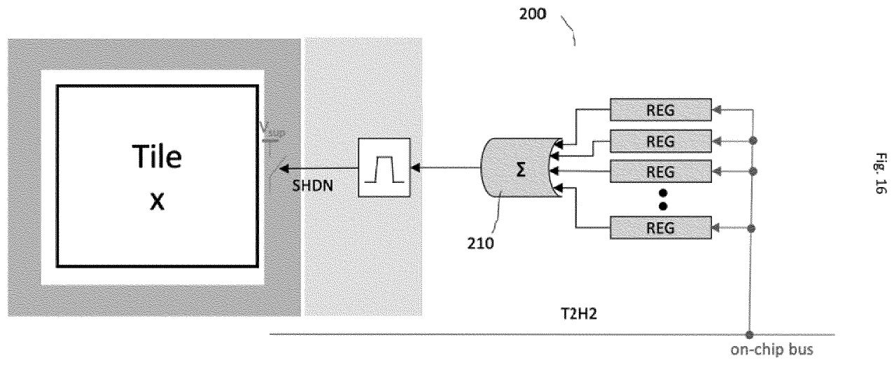

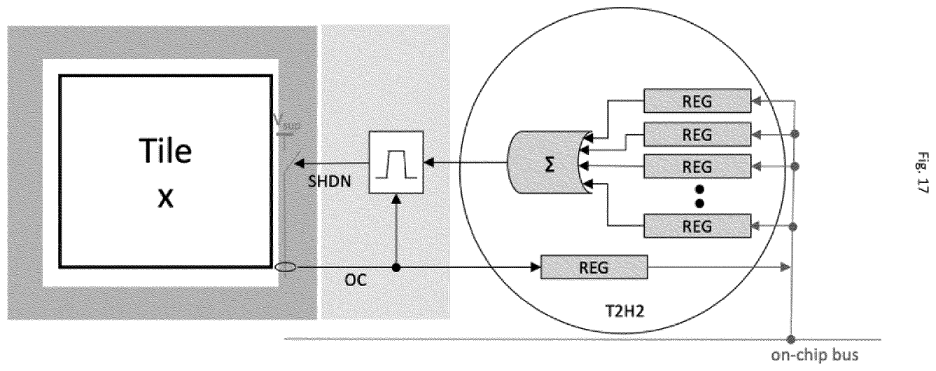

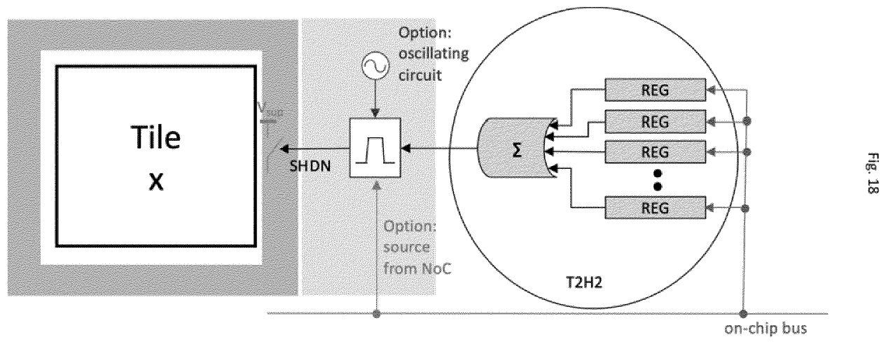

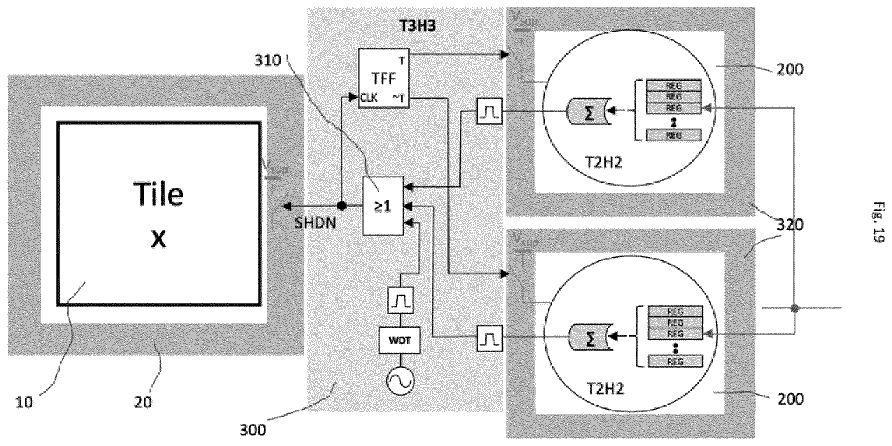

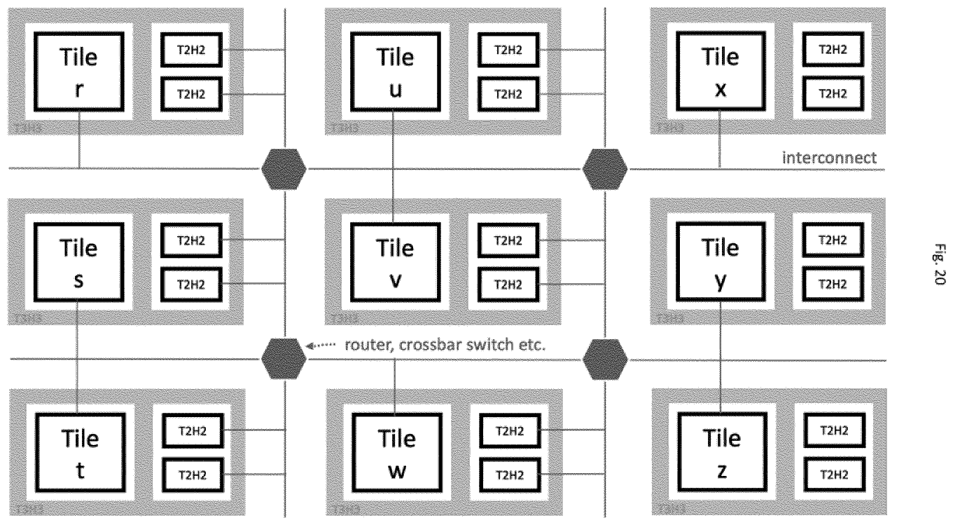

FIG. 14 shows a method for re-active fault removal.

The present invention defines several instances of apparatuses for mitigating radiation effects (and other accidental types of faults). The apparatuses are multi and manycore systems on a chip (MPSoCs) extended by units to secure the electronic circuits that make up the MPSoC from SELs and other radiation effects. In particular, SHARCS focuses on those MPoCs that are implemented on technology nodes that have no natural resistance to radiation effects (unlike SOI). The SHARCS units integrate into multi- and manycore systems to form the apparatuses of this invention to power cycle and recover a subset of the circuits, while relocating the required functionality to the remaining active subset.

The ability to power cycle only part of the multi- or manycore system is essential for keeping available most of the system's functionality on the computational resources that are not currently power cycled, while avoiding cross-chip migrations.

The following apparati incrementally improve the protection against uncontrolled propagation of faults due to single- and multi-event upsets and the efficiency of implementation of SHARC's SEL countermeasures. We describe these SEL countermeasures abstractly as a power cycling mechanism that is controlled by a power-cycling controller, which indicates when to proactively or reactively switch off power supply to each tile, on-chip network segment and other circuits in the system. The following are concrete instances of these abstract units.

Power Cycling Mechanism

SHARCS apparati make use of the following depowering mechanism to electrically isolate a circuit (in this example a tile) from the rest of the system during a power-cycling process. We call this mechanism Isolation Circuitry, or short ISOL.

Electrical isolation shall be applied to all power supply lines and all input and output lines. In the example in FIG. 1, these are the supply (Vₛᵤₚ) and ground (GND) power lines that supply the circuits in the tile with power and all input/output lines that connect the tile to the on-chip network. Removing power supply shall be by means of disconnecting all supply voltages and (optionally) by shorting all of them to ground, while input-output buffers disconnect all inputs and outputs and electrical isolation of tiles' IO lines from the rest of the system. The Isolation Circuitry is controlled by a single signal—SHDN (SHutDowN), which is enabled to switch off the power supply and disabled to resupply power. The power-cycling controller monitors the SHDN signal to detect upsets and drives it to power cycle the embedded circuit. Moreover it connects to the OC (OverCurrent) signal to detect regular SELs.

In the remaining figures, we shall indicate the isolation circuit with the rectangle, wrapping the circuit it protects and omit for clarity the concrete IO and power lines it controls.

On-Chip Power Cycling Mechanisms and Control.

Central Singular On-Chip Depowering Controller (A.0)

FIG. 2 shows the schematic how a singleton power-cycling controller (CTRL) connects to a power cycling mechanism (in case of SHARCS' ISOL, the SHDN and OC signals) to control which tile undergoes power cycling (red) and which tiles remain active (green). We show the signals separately for ease of presentation but of course CTRL connects to both sets of wires at the same time, while driving them at different times and only selected SHDN signals.

Clearly, any upset in CTRL and any SEL in this circuit may jeopardize availability of the system functionality, by accidentally driving the SHDN signal of all tiles or by thermal breakdown due to unhandled SELs in CTRL might turn off the protection mechanism that was supposed to guarantee tiles' seamless operation despite occurrence of faults.

To mitigate those issues, the CTRL circuit shall be manufactured in high-reliability, SEU tolerant and SEL immune technology. Unlike tiles, which shall be high complexity and performance circuits, CTRL is responsible only for monitoring of the tiles behavior and management of their proactive and reactive recovery from occurring faults, so making it robust, shall be both sufficient and feasible.

The presented setup involving, tile-level granularity of protection mechanism application and system-wide operation orchestration, employed for safety assurance of the cores susceptible to radiation induced error, performed by external controller manufactured in high reliability technology, is itself a solution containing inventive step, sufficient for claiming the protection.

Tandem Power Cycling Controller (A.1)

Tandem control, as illustrated in FIG. 3, avoids possible damage due to CTRL latch-ups by allowing one controller of the tandem pair to disable the other. While power cycling CTRL₁, CTRL₂ disconnects the OCᵢ lines from CTRL₁ and takes over that controller's responsibility to deal with overcurrent. CTRL₂ also disconnects CTRL₁'s SHDN; lines and as well assumes CTRL₁'s role in driving these signals for the circuits that undergo a depowering cycle. Once CTRL₁'s power cycle completes, CTRL₂ undergoes such a cycle with CTRL₁ taking over its role.

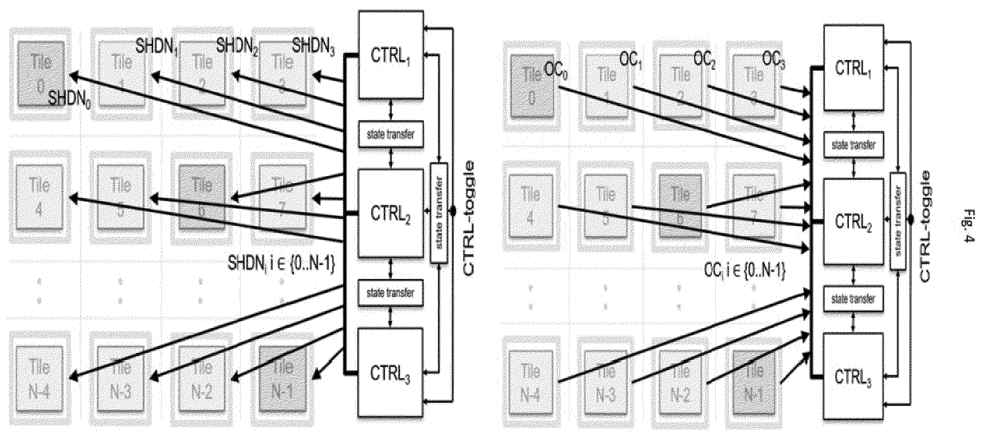

The implementation challenge with tandem circuits lies in the simultaneous requirement to exchange the state of which circuits are in a depowering cycle without introducing another circuit that is not also subject to power cycling. Before we provide a solution for a secure state exchange in tandem, let us introduce an architecture in FIG. 4 to avoid this problem.

Triple Depowering Controller (A.2)

The triple power-cycling controller architecture instantiates three power-cycling controllers, each connected to the SHDNᵢ and OCᵢ signals of the protected circuits and the controllers and each pair of them with a state element between them, that can be power cycled as well. Controllers rotate responsibilities, while transitioning the state through the state element between the active pair (i.e., the one handing over control and the one receiving depowering control). The state element between the third and the one handing over control is thereby unused and can be power cycled in the course of this handover.

Tandem State Transfer (A.1a)

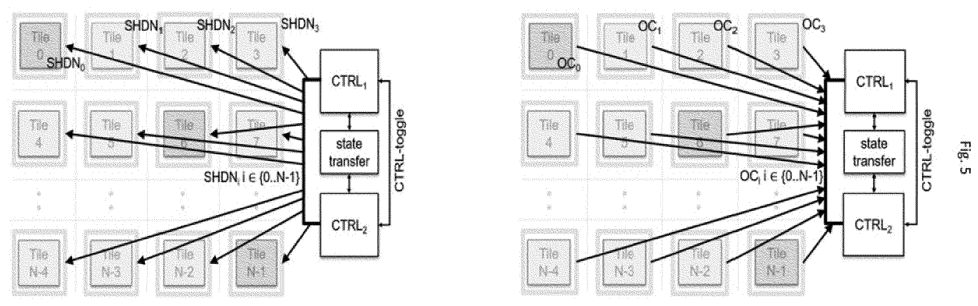

As shown in FIG. 5, the CTRL can be designed and programmed in a way, at a time, one of the controllers is active (acting on SHDNᵢ lines), while other controller is passive (observing states on SHDNᵢ lines). The passive controller, by observing how SHDNᵢ are asserted and de-asserted, follows the execution of tile power cycling algorithm running on the active controller, and can intervene and take-over control from the active one by activating CTRL-toggle line. The CTRL interface to SHDNᵢ lines has to be designed and implemented in a way that input-output short or stuck-at fault does not propagate to other controller. Similarly, the OCᵢ lines interface, shall ensure on error is propagated to other controller.

Controller Internals

So far, we left abstract the internals of the controller instances CTRLᵢ. In the following we introduce important building blocks in the understanding that any combination of them can be instantiated with the effects discussed below.

Periodically Triggered Power Cycling (C.1)

Depowering of a circuit should be triggered periodically and phase shifted to the depowering of other circuits to avoid missing undetected SELs. Controller element C.1 therefore periodically raises a SHDNᵢ signal of a certain circuit i for a time tᵢ that is long enough to remove SELs from this circuits and with a period pᵢ and offset ϕᵢ. The parameters tᵢ, pᵢ, and ϕᵢ depend on the protected circuit, harshness of radiation environment and should be chosen to cause the signal to be asserted when time comes to power cycle dependent circuit For example, for the special instance of tiles of similar kind and network on chip (NoC) segments that connect these tiles, all periods pᵢ and power cycling times tᵢ assume approximately the same value t and p. Phases of a tile and its data connecting NoC segment should therefore be the same while phases should be multiples of t, such that no two tiles have the same phase. Setting ϕᵢ=t i fulfills this condition, if we further assume that p>t n where n is the number of tiles in the system. FIG. 6 illustrates such a controller.

Threshold Triggered Power Cycling (C.2)

Measuring the current (in search for overcurrent event caused by strong latchup) one can and should of course react to those latch-ups that can be detected. Once the such sensed signal exceeds a threshold, the OC signal is asserted, indicating latch-up detection. FIG. 5 shows the circuit elements for such a detection.

Software Triggered Power Cycling (C.3)

Most flexibility, in particular the possibility to adjust to varying environmental conditions, are achieved by controlling the raising/lowering of the SHDN signals with software executed on a microcontroller, which is possibly connected through sensors of the environment. Software of this kind follows the standard control loop pattern, i.e., read environment, adjust internal state, derive outputs (e.g., in the form of periodic signals as indicated in C.1 but with periods adjusted to the current resource usage of the system (e.g., unused tiles are natural candidates to undergo powercycling) and with periods pᵢ adjusted to the perceived environmental conditions (e.g., to the measured radiation level).

Controller Combination (C.1-C.3)

As indicated, the above controllers integrate smoothly to provide their combined effect, as illustrated in FIG. 6. Sensor, oscillator or the reception of a corresponding message from software over the NoC triggers SHDN. Obviously, for the latter to work, the network segment through which the disable signal, but more importantly, reenable are triggered, must not undergo power-cycling simultaneously with the protected tile. We therefore suggest drawing this signal from another network segment that will be power cycled separately.

Consensual Power-Cycling Control

The apparati introduced so far exhibit little to no protection against upsets in the power-cycling controllers and in particular in the wires that connect to SHDN and OC. The following extensions therefore integrate upset protection with power-cycling control. Even if a tile is depowered, upsets may occur at its interface wires. If this signal is allowed to propagate through the system in an uncontrolled way, it may cause subsequent faults in other components of the system. To protect against such propagation, several techniques can be applied, which all involve trusted-trustworthy components to prevent uncontrolled propagation. For example, such a component could encode outgoing signals to detect errors during transmission or block transmissions that are not legitimate. The main constraint is that any such protection mechanism, suitable of preventing access and fault-propagation, must remain active, even when the tile is power cycled. However, as we have seen with the power-cycling controller (CTRL), singleton active circuits bear the risk of SEL damage, if not implemented in high reliability technology.

The second aspect to prevent fault propagation is to make sure that any critical operation, including power cycling, is controlled in a consensual manner. That is no single, potentially faulty component should be able to trigger such a critical operation. Instead, such a decision should always be the result of a set of components (some of which faulty) reaching agreement about such a decision in a way that the faulty replicas cannot influence this decision. Related work on Byzantine agreement quantifies this result for agreement with a trusted-trustworthy component to a cardinality of n components of which f may be faulty, where n and f are related as n=2f+1. This number increases by k (i.e., n=2f+1+k) if up to k out of the n components should undergo power cycling simultaneously, while the remaining n−k components continue to reach agreement about this process, while masking the proposals of the up to f faulty replicas.

In the following, we now introduce the apparati that are required for consensual power-cycling:

Voted Activation/Deactivation of SHDN. (AC1)

FIG. 7 illustrates the voted activation of the SHDN, where shutdown is asserted when a quorum of simultaneously active CTRL agree. Each SHDNᵢ signal is reflected as n signals SHDNᵢ (j in [1, . . . , n]) such that SHDNᵢ is connected to CTRLⱼ. The vector SHDNᵢ^{j} is then mapped to SHDNᵢ by counting the number of bits set either in combinatorial logic or in an analog way (using wire vote and an operational amplifier as threshold comparator). Depending on the implementation (C.1-C.3) the CTRL replicas may be a combination of the electronic circuits described as C.1 or C.2 or dedicated microcontrollers (C.3).

Tiles as CTRL (AC2)

Once fault tolerant privilege enforcement is in place (e.g., through integration and adaptation of Midir), ordinary tiles may host the control software and contribute the to be voted upon proposal (possibly in combination with C.1 and/or C.2) as illustrated in FIG. 8.

However, as mentioned above, no singular circuit must remain that is not power cycled and where SELs may build up. The final ingredient is therefore:

Tandem fault containment through state-decoupled trusted trustworthy components. As shown in FIG. 9

To fulfil the requirement that at least one trusted trustworthy component remains active and available to prevent the uncontrolled propagation of faulty requests, SHARCS leverages the tandem concept introduced for CTRL. The trusted trustworthy component (here as an example Midir's T2H2) is duplicated such that one of the components remains active while the other can undergo power cycling. In this state-decoupled setting, the just power-cycled component must be either stateless or reconfigured by other components through its regular reconfiguration interface, before it can reused again. In case of Midir, these are voted operations about the values to be installed in registers. A toggling T flipflop (TFF) controls which of the two components is currently active, is vital part of T3H3, a 2nd level hybrid protecting and managing both, tile and their 1st level hybrid blocks (like T2H2 presented in examples, but not limited to).

T3H3 comprises of trusted voter, digital or analog, as described earlier, collecting votes on whether given tile shall protected. In case quorum is reached a pulse is generated and fed into ≥1 gate (“or”, logic alternative). Alternatively to pulse generated by voting, if quorum and agreement to power cycle given tile is not reached, another pulse will be generated by overflowing watchdog counter (WDT), clocked by local oscillator circuit. Either way, pulse propagates through ≥1 gate (OR gate) and is provided as a SHDN signal to ISOL isolation circuit of the tile, and as a clock to toggling flip-flop TFF, causing it to toggle between T2H2 hybrid protection modules.

Tandem fault containment with state-coupled trusted trustworthy components.

As shown in FIG. 10, for some trusted-trustworthy components, it is not indicated for security or performance reasons that the component is reinitialized by external units. This is for example the case if key material is derived or if the operations for reinstantiating state would be too costly. In this case, T3H3 can be adapted to keep both trusted components active, by signaling thought the TTF only the turn, but waiting for the state transfer to complete before depowering the component whose turn it is to be power cycled.

The various aspects and exemplary embodiment of the invention can now be rephrased as follows:

An appropriate adapted circuit (tile), adapted for recovery from (radiation induced) (non-transient) faults, is provided. In an exemplary embodiment over current detecting circuit is used to detection such fault. Circuits suited for autonomous overcurrent event detection with a local approach, for instance generating appropriate controls signals while exceeding a first threshold of the current are provided. Likewise circuit suited for autonomous overcurrent event detection supporting a global approach are also provided. Moreover those approaches may be combined.

In some embodiments one or more pulse generation circuit, whereby said pulse generation circuit(s) being provided by timing signals, either generated locally by means of one or more oscillation circuit, or adapted for receiving timing signal via communication means otherwise are provided.

The threshold to compare the (communicated) over current with may on purpose differ from circuit (main and/or second protection means) to circuit (in the process of generating an appropriate control signal) to avoid shutting down simultaneously.

The invention suggests that a method for fault removal in a system is based on a combination of the re-active methods and pro-active method, possibly the (pro-active) method takes into account the latest trigger of the (re-active) method.

Within the invention said second protection means can be considered as a state machine and hence the methods ensure that prior to switching of a second protection means, the state of said second protection means to be switched off, is transferred one or more of the other of said plurality of second protection means (if possible). This could be to a neigh-boring circuit but this is not required.

The invention may leverage on the presence of a sensor for determining the radiation level. Alternatively the invention may rely on means for inputting information on the radiation level (expected). Yet another alternative is that the radiation level (experienced) is determined from the activating of the re-active fault removal methods. The radiation level (experienced) can also be determined from the activating of mechanisms (like ECC correction) to handle transient radiation induced faults, being provided in one or more of the circuits. These various methods can be also combined.

1. Circuit, adapted for recovery from and/preventing of radiation induced faults, comprising a main circuit;
power supply means to connect said main circuit to power lines; and
communication connect means to connect said main circuit to communication means, characterized in that the circuit further being provided with first protection means comprising: a means for detecting occurrence of such radiation induced faults; one or more switching means, provided in between either said power supply means or said communication connect means and said main circuit to disconnect therefrom and reconnect thereto respectively in case of occurrence of such radiation induced faults or action to prevent occurrence thereof upon reception of a control signal generated by use of said fault occurrence detection and maintained to ensure that said disconnection is sufficiently long for all the voltages, measured with respect to system ground, to drop to zero, while ensuring that no current flows through the device thereby removing said radiation induced faults.

2. The circuit of claim 1, further being provide with a second protection means capable to receive a plurality of input signals, and to generate the control signal based on said plurality of input signals (based on a voting circuit).

3. The circuit of claim 2, comprising: a plurality of said second protection means themselves connected to power lines and provided with a first protection means; and a third protection means, to disconnect said power lines, and reconnect thereto, of said second protection means via their respective first protection means respectively in case of occurrence or prevention of such radiation induced faults, and to select, for instance via circuit for combination or a Boolean function implementing a voting approach, the outcome of the active one of said second protection means.

4. The circuit of claim 1, wherein said main circuit is more complex than said second protection means and, if applicable, said second protection means is more complex than said third protection means, in that the more complex ones being less intrinsic resistant to radiation induced events.

5. The circuit of claim 1, wherein one or more of: said main, said second protection means or third protection means are provided with mechanisms to handle transient radiation induced faults.

6. System adapted for at least one of recovery from and prevention of radiation induced faults, comprising circuits of claim 1; and
communication means to enable communication between said circuits, to which said circuits are connected.

7. The system of claim 6, further comprising a central control circuit, configured for receiving information, generating said control signals or both.

8. The system of claim 7, wherein said central control circuit comprises a computation engine, adapted for executing one or more of the methods 10 to 15.

9. The system of claim 8, comprising a storage medium comprising instructions which when executed by the computation engine cause the computation engine to execute the methods 10.

10. A method for re-active fault removal in a system in accordance with claim 6, whereby based on detecting of radiation induced faults in one or more of said main circuits, a control signal is generated to switch off at least one of said main circuit and second protection means the method comprising:
receiving information related to detecting of radiation induced faults; switch off the related circuit; and switch on said circuit after a predetermined period has lapsed.

11. A method for fault removal in a system in accordance with claim 6, wherein in addition to the method of claim 10, a method for proactive fault removal in said system is executed, wherein control signals to switch off and on periodically at least one of said main circuits and second protection means are generated, the method comprising: receiving information related to at least one of detecting of radiation induced faults and determining that time to proactive switch off has come, switch off the related circuit accordingly; and switch on said circuit after a predetermined period has lapsed.

12. The method of claim 11, the method being central, with a system in accordance with claim 7, whereby said central control circuit generates said control signals.

13. The method of claim 11, the method being distributed, whereby said circuits themselves generates said control signals.

14. The method of claim 10 wherein prior to switching off a circuit, when possible, the task is transferred to another circuit.

15. The method of claim 10 wherein said system is managed in that circuits are reserved to ensure that, prior to switching off a circuit, it is possible, that the task is transferred to another circuit.
